(19) United States
(12) Patent Application Publication
(10) Pub. No.: US 2024/0403631 A1
(43) Pub. Date: Dec. 5, 2024

(54) NEURAL NETWORK ACCELERATOR WITH IMPROVED LEARNING PERFORMANCE AND OPERATION METHOD THEREOF

(71) Applicants: SK hynix Inc., Icheon-si (KR); Korea Advanced Institute of Science and Technology, Daejeon (KR)

(72) Inventors: Haeyoon CHO, Gyeongsan-si (KR); Hyojun Son, Busan (KR); John Dongjun Kim, Seoul (KR); Jungmin Choi, Icheon-si (KR); Byungil Koh, Icheon-si (KR); Minho Ha, Icheon-si (KR)

(21) Appl. No.: 18/520,276

(22) Filed: Nov. 27, 2023

(30) Foreign Application Priority Data
Jun. 5, 2023 (KR) 10-2023-0072224

(51) Int. Cl. G06N 3/08

(52) U.S. Cl. CPC G06N 3/08

(57) ABSTRACT

A neural network accelerator includes a control circuit configured to control a learning operation for a neural network by performing a plurality of learning steps; an operation processor configured to perform the learning operation under the control of the control circuit; and an operation memory storing the embedding table that has a plurality of embedding entries and coupled to the operation processor, wherein the operation processor performs a first embedding operation using an embedding entry required for a current learning step, and performs a second embedding operation using an embedding entry that is required for a next learning step and is not affected by the current learning step.

### CROSS-REFERENCE TO RELATED APPLICATION

The present application claims priority under 35 U.S.C. § 119(a) to Korean Patent Application No. 10-2023-0072224, filed on Jun. 5, 2023, which is incorporated herein by reference in its entirety.

### BACKGROUND

### 1. Technical Field

Various embodiments generally relate to a neural network accelerator and an operation method thereof, capable of enhancing learning performance by increasing hardware resource utilization efficiency during a learning operation.

### 2. Related Art

A deep learning recommendation model (DLRM) is a type of deep neural network that is widely used in fields such as advertising and content recommendation.

FIG. 1 is a block diagram showing a conventional DLRM 1.

The DLRM 1 includes a bottom multi-layer perceptron (MLP) 10, an embedding layer 20, an interaction layer 30, and a top MLP 40.

The bottom MLP 10 receives dense feature vectors and performs operations based on the dense feature vectors. The embedding layer 20 includes one or more embedding tables, e.g., N embedding tables 21, and receives sparse feature vectors and performs embedding operations based on the sparse feature vectors.

When a neural network accelerator includes multiple graphics processing units (GPUs), an operation of the bottom MLP 10 and an operation using the one or more embedding tables 21 may be distributed and performed on the multiple GPUs.

The interaction layer 30 performs operations such as concatenation, addition, and dot product on an output of the bottom MLP 10 and an output of the embedding layer 20.

The top MLP 40 performs neural network calculation on an output of the interaction layer 30, and outputs a recommendation result.

In the DLRM 1, the bottom MLP 10, the top MLP 40, and the interaction layer 30 mainly use computation-oriented hardware resources in the neural network accelerator, and the embedding layer 20 mainly uses memory-oriented hardware resources in the neural network accelerator.

When a neural network accelerator includes multiple GPUs to perform a distributed processing operation, communication-related hardware resources in the neural network accelerator are mainly used to perform operations, such as an All-to-All (A2A) operation and an All Reduce (AR) operation, in order to transfer calculation results between the multiple GPUs.

A conventional neural network accelerator divides learning data into a plurality of batches and performs a learning operation for each batch. The learning operation includes multiple learning steps, each including a forward propagation operation and a backward propagation operation, to adjust weights of a neural network.

FIG. 2 shows a learning operation of a conventional neural network accelerator.

The conventional neural network accelerator sequentially performs a forward propagation operation and a backward propagation operation included in the learning operation, and repeatedly performs the learning operation, using a plurality of batches of learning data.

FIG. 2 shows a forward propagation operation and a backward propagation operation for an i-th batch that are performed in the conventional neural network accelerator, wherein i is a natural number.

In FIG. 2, B-MLP represents a bottom MLP, e.g., the bottom MLP 10 of FIG. 1, IL represents an interaction layer, e.g., the interaction layer 30 of FIG. 1, and T-MLP represents a top MLP, e.g., the top MLP40 of FIG. 1.

In the forward propagation operation, a computation operation of the bottom MLP 10, B-MLP Comp, and a memory operation of the embedding layer 20, Embedding Operation, are performed.

After that, an A2A operation, which is a communication operation for sharing information between multiple GPUs, is performed. After that, a computation operation of the interaction layer 30, IL Comp, and a computation operation of the top MLP 40, T-MLP Comp, are performed.

In the forward propagation operation, a loss function is calculated using an operation result of the top MLP 40 and a truth value.

In the backward propagation operation, a computation operation of the top MLP 40, T-MLP Comp, is first performed.

Thereafter, an AR operation is performed. The AR operation is a communication operation in which gradient values generated as a result of an operation of the top MLP 40 performed on the multiple GPUs are collected to derive a predetermined calculation result, such as an average, a summation, a maximum, and etc. of the gradient values, and the calculation result is distributed to the multiple GPUs.

In FIG. 2, this AR operation is indicated by AR (T). After the AR (T) operation is performed, coefficients of the top MLP 40 are updated.

Thereafter, a computation operation IL Comp is performed in the interaction layer 30, and a computation operation B-MLP Comp is performed in the bottom MLP 10, After that, an AR operation, which is a communication operation, is performed using some result output from the bottom MLP 10. In FIG. 2, this AR operation is indicated by AR (B), and coefficients of the bottom MLP 10 are updated after the AR (B) operation is performed.

In addition, an A2A operation is performed using other results output from the bottom MLP 10, and one or more embedding tables, e.g., the embedding tables 21 of FIG. 1, are updated using results of this A2A operation.

Since the embedding tables 21 included in the embedding layer 20 are expansive, with each table occupying space ranging from several gigabytes to several terabytes, the relatively slow memory operation during the embedding operation becomes the primary factor leading to the deterioration of learning performance.

### SUMMARY

In accordance with an embodiment of the present disclosure, a neural network accelerator may include a control circuit configured to control a learning operation for a neural network by performing a plurality of learning steps; an operation processor configured to perform the learning operation under the control of the control circuit; and an operation memory storing an embedding table that has a plurality of embedding entries and coupled to the operation processor, wherein the operation processor performs a first embedding operation using an embedding entry required for a current learning step, and performs a second embedding operation using an embedding entry that is required for a next learning step and is not affected by the current learning step . . .

In accordance with an embodiment of the present disclosure, an operation method of a neural network accelerator that performs a learning operation for a neural network and includes an embedding table, the operation method may include performing a current learning step for learning the embedding table by using i-th batch data of learning data; and performing a next learning step for learning the embedding table by using (i+1)-th batch data of the learning data, wherein the current learning step includes: performing a first embedding operation using an embedding entry of the embedding table that is required for the current learning step; and performing a second embedding operation using an embedding entry of the embedding table that is required for the next learning step and is not affected by the current learning step, and wherein i is a natural number.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate various embodiments, and explain various principles and advantages of those embodiments.

FIG. 1 illustrates a conventional deep learning recommendation model.

FIG. 2 illustrates an operation method of the conventional deep learning recommendation model.

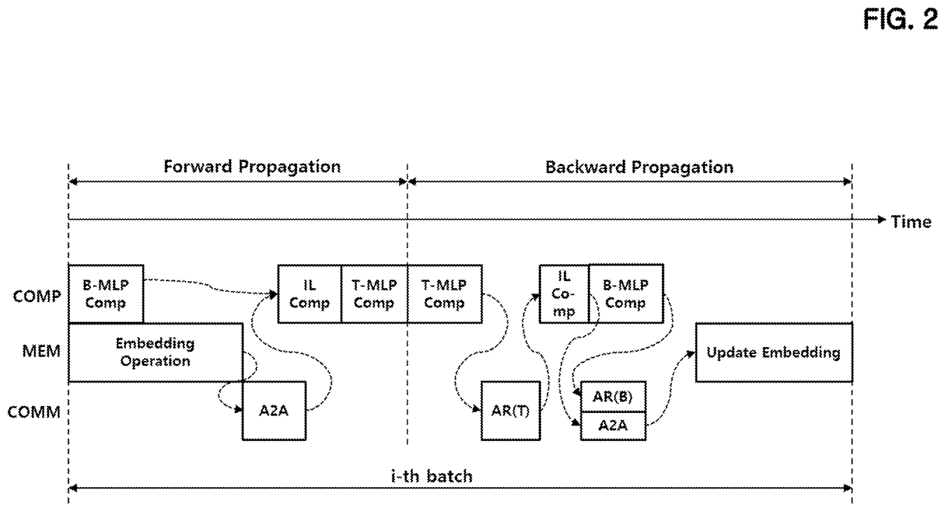

FIG. 3 illustrates an operation method of a deep learning recommendation model according to an embodiment of the present disclosure.

FIG. 4 illustrates a neural network accelerator according to an embodiment of the present disclosure.

FIGS. 5A to 5C illustrate data stored in a GPU memory according to an embodiment of the present disclosure.

FIG. 6 is a state diagram illustrating states of an embedding entry according to an embodiment of the present disclosure.

### DETAILED DESCRIPTION

The following detailed description references the accompanying figures in describing illustrative embodiments consistent with this disclosure. The embodiments are provided for illustrative purposes and are not exhaustive. Additional embodiments not explicitly illustrated or described are possible. Further, modifications can be made to presented embodiments within the scope of teachings of the present disclosure. The detailed description is not meant to limit this disclosure. Rather, the scope of the present disclosure is defined in accordance with claims and equivalents thereof. Also, throughout the specification, reference to “an embodiment” or the like is not necessarily to only one embodiment, and different references to any such phrase are not necessarily to the same embodiment(s).

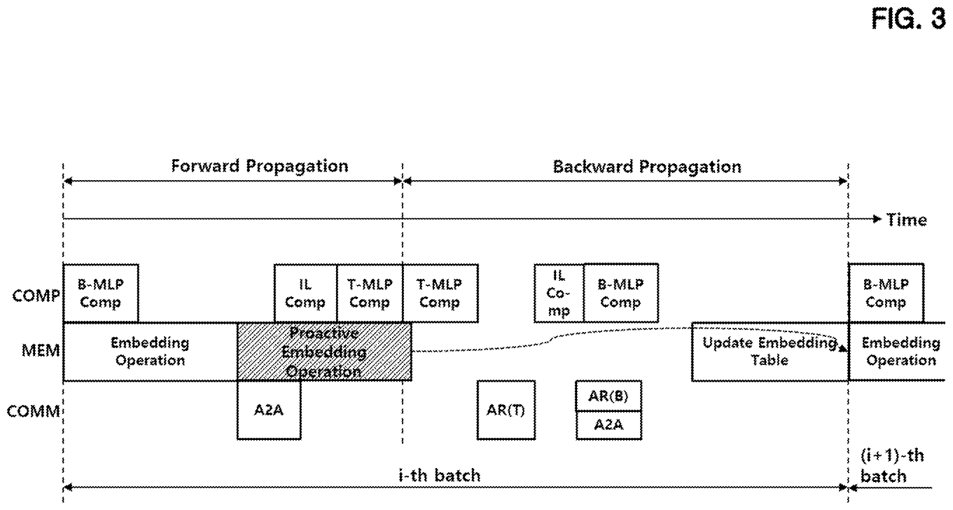

FIG. 3 illustrates a learning operation of a neural network accelerator according to an embodiment of the present disclosure.

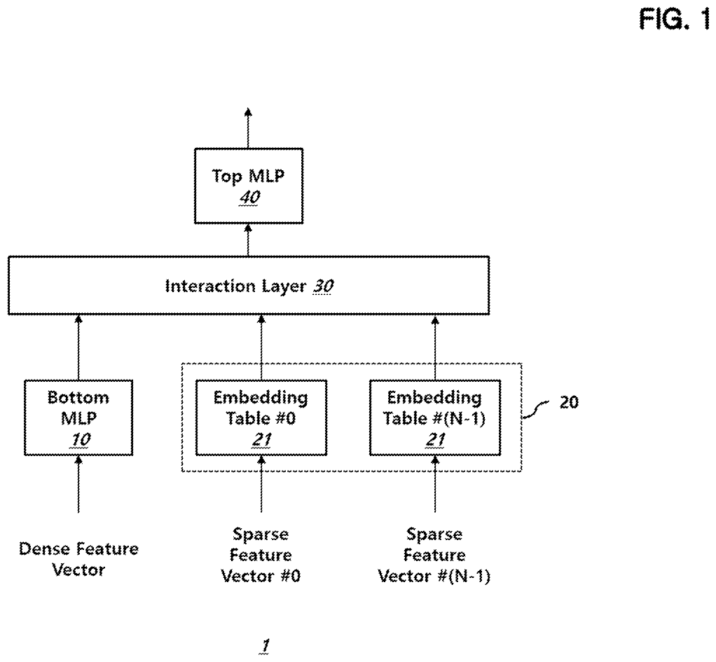

It is assumed that a neural network to be trained by the neural network accelerator according to the embodiment of the present disclosure is the same as the deep learning recommendation model (DLRM) 1 of FIG. 1. Therefore, the learning operation illustrated in FIG. 3 will be described with reference to the DLRM 1 of FIG. 1.

In the learning operation according to this embodiment, a forward propagation operation and a backward propagation operation are performed for each batch to update weights of the bottom multi-layer perceptron (MLP) 10, the top MLP 40, and the embedding tables 21 included in the embedding layer 20.

FIG. 3 shows a learning step for an i-th batch. Hereinafter, the learning step for the i-th batch is referred to as a current learning step or a current step, and a learning step for an (i+1)-th batch is referred to as a next learning step or a next step. Here, i is a natural number.

The neural network accelerator according to this embodiment is characterized in that it performs a proactive embedding operation while performing the forward propagation operation.

In this embodiment, the proactive embedding operation corresponds to an operation of pre-reading an embedding entry, which is to be used in the next learning step and is not affected by the current learning step, i.e., is not used in the current learning step, from a memory. The proactive embedding operation may include a computation operation using data such as the embedding entry pre-read from the memory.

In FIG. 3, an embedding operation performed before the proactive embedding operation may be referred to as a first embedding operation, and the proactive embedding operation may be referred to as a second embedding operation.

Not all embedding entries of embedding tables are used when performing a learning step for any one batch in the learning operation of the neural network including the embedding tables.

In the present disclosure, among embedding entries required for the next learning step, embedding entries not affected by the current learning step are read in advance through the proactive embedding operation.

Such a proactive embedding operation may be performed while a computation operation and a communication operation are performed in the current learning step, and thus, the time needed for the proactive embedding operation may be hidden.

Through this, the time needed for a memory operation in the next learning step is reduced, leading to improved overall neural network learning performance.

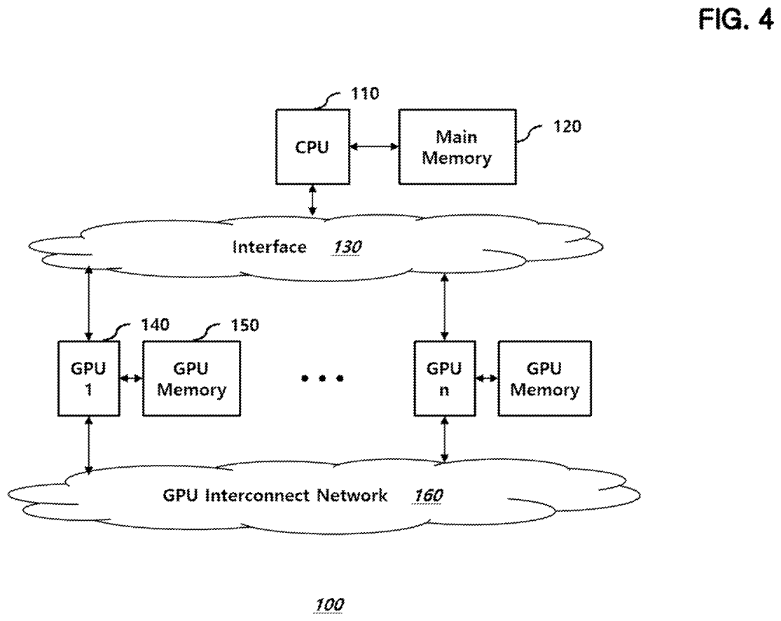

FIG. 4 is a block diagram showing a neural network accelerator 100 according to an embodiment of the present disclosure.

The neural network accelerator 100 includes a central processing unit (CPU) 110, a main memory 120 connected to the CPU 110, an interface 130, a graphics processing unit (GPU) 140 connected to the CPU 110 through the interface 130, and a GPU memory 150 connected to the GPU 140, and a GPU interconnect network 160 connecting the GPU 140 to one or more other GPUs.

In this embodiment, the GPU 140 is a processor that executes neural network learning operations under the control of the CPU 110. The GPU 140 may be referred to as an operation processor, the GPU memory 150 may be referred to as an operation memory, and the GPU interconnect network 160 may be referred to as an operation processor interconnect network.

In this embodiment, the neural network accelerator 100 includes a plurality of GPUs 140, e.g., GPU1 to GPUn, and the plurality of GPUs 140 may perform neural network learning operations in parallel. The plurality of GPUs 140 may transmit and receive data therebetween through the GPU interconnect network 160.

The structure of the neural network accelerator 100 shown in FIG. 4 and a learning operation performed using the neural network accelerator 100 are well known. Therefore, descriptions of general structures and operations that overlap with prior art will be omitted for illustrative convenience.

The CPU 110 controls a neural network learning operation using the plurality of GPUs 140. Accordingly, the CPU 110 may be referred to as a learning control circuit.

For example, the CPU 110 may instruct an operation of the bottom MLP 10, which is indicated as the B-MLP operation in FIG. 3, and the GPU 140 may perform the B-MLP operation accordingly. In addition, the CPU 110 may instruct an embedding operation, and the GPU 140 may perform the embedding operation accordingly.

In this embodiment, the CPU 110 controls the GPU 140 to perform an embedding operation necessary for the next learning step, that is, to perform a proactive embedding operation while performing the current learning step. The GPU 140 executes the proactive embedding operation accordingly.

In this embodiment, it is assumed that one GPU 140 performs an embedding operation using any one of a plurality of embedding tables to distribute the neural network learning operation, but the relationship between the GPU 140 and the embedding table is not limited thereto.

The GPU memory 150 stores an embedding table, input data necessary for the embedding operation, and output data that is generated as a result of the embedding operation.

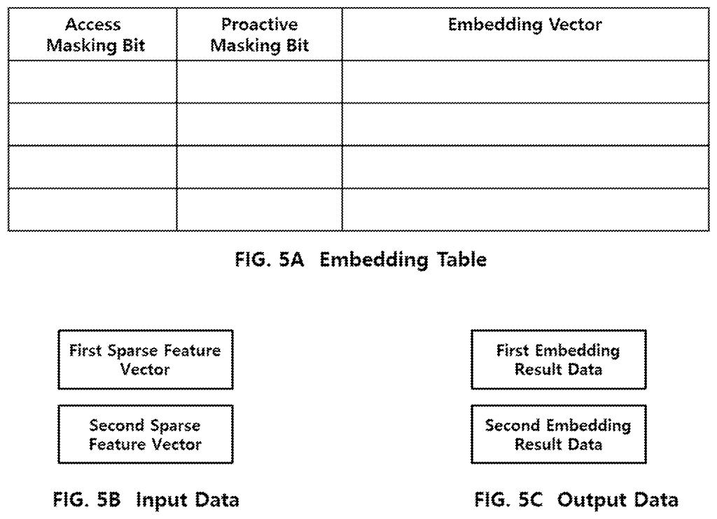

FIGS. 5A to 5C show types of data stored in the GPU memory 150 of FIG. 4.

As described above with reference to FIG. 4, the GPU memory 150 stores an embedding table corresponding to the GPU 140, input data to be used during an embedding operation, and output data that is generated as a result of the embedding operation.

In this embodiment, the embedding table includes a plurality of embedding entries, each embedding entry may be referred to as an embedding vector, and the embedding table further includes state data corresponding to each embedding entry.

The embedding vector includes a number of element values, and each element value can be updated during a learning operation.

The state data indicates a state of the corresponding embedding entry.

In this embodiment, the state data is 2-bit data and includes an upper bit and a lower bit.

The upper bit is used as an access masking bit and indicates whether an embedding operation is performed for the corresponding embedding entry in the current learning step. The upper bit may be referred to as a first bit.

The lower bit is used as a proactive masking bit and indicates whether a proactive embedding operation is performed for the corresponding embedding entry. The lower bit may be referred to as a second bit.

The input data includes a first sparse feature vector and a second sparse feature vector. The first sparse feature vector corresponds to input data required for the embedding operation in the current learning step, and the second sparse feature vector corresponds to input data required for an embedding operation in the next learning step.

Since a batch contains a plurality of input data, the batch may include a plurality of first sparse feature vectors and a plurality of second sparse feature vectors.

The CPU 110 may provide a corresponding GPU memory 150 with input data necessary for the current learning step and input data necessary for the next learning step among input data stored in the main memory 120 for the entire learning operation.

Since a method for the CPU 110 to transmit input data stored in the main memory 120 to the GPU memory 150 itself is a conventional technique, the disclosure thereof will be omitted.

By referring to the first sparse feature vector and the second sparse feature vector calculated with the embedding table, it is possible to find an embedding entry required for the next learning step without being affected by the current learning step.

The CPU 110 controls a proactive embedding operation, and can determine whether the proactive embedding operation is required by comparing input data required for the current learning step with input data required for the next learning step. Accordingly, when the input data required for the current learning step is different from the input data required for the next learning step, the proactive embedding operation can be instructed to the corresponding GPU 140.

In another embodiment, when an embedding operation is terminated during a forward propagation operation, the GPU 110 determines whether a proactive embedding operation is possible by referring to the first sparse feature vector and the second sparse feature vector included in the input data. The proactive embedding operation may be initiated according to the determination result.

The output data includes first embedding result data and second embedding result data. The first embedding result data indicates an embedding result of the current learning step, and the second embedding result data indicates a proactive embedding result performed for the embedding operation of the next learning step.

Returning to FIG. 4, each GPU 140 may additionally perform distributed processing for the bottom MLP 10.

For example, each GPU 140 may perform an operation of the same bottom MLP 10, where input data included in one batch may be divided for the distributed processing. For example, if there are a plurality of input data in one batch, each GPU 140 may perform the operation of the bottom MLP 10 using a corresponding one of the plurality of input data.

Accordingly, the GPU memory 150 may additionally store dense feature data corresponding to weights of the bottom MLP 10 and output data corresponding thereto.

In the same way, the GPU 140 may additionally perform distributed processing for the top MLP 40, and a repetitive description thereof will be omitted.

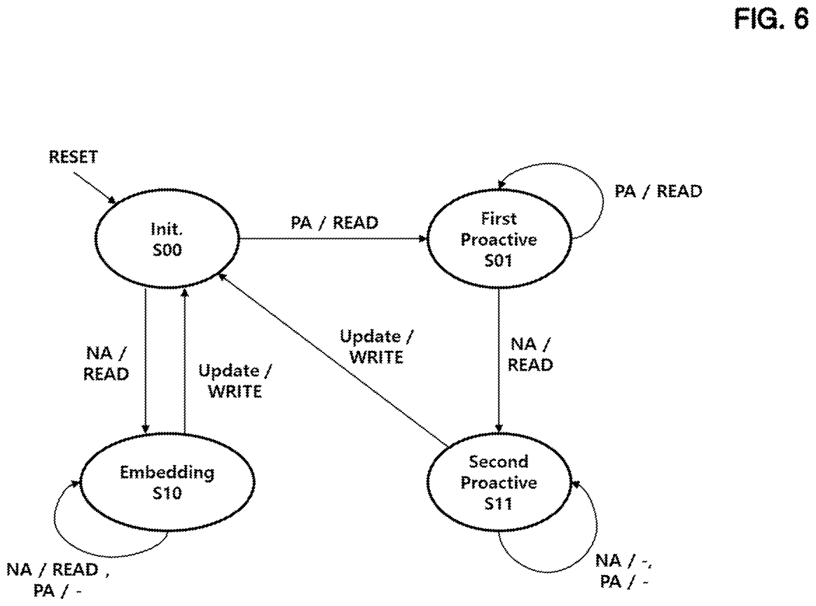

FIG. 6 is a state diagram showing a state of an embedding entry during a learning operation according to an embodiment of the present disclosure.

When a reset signal RESET is input, an embedding entry transitions to an initial state S00.

In the initial state S00, both a first bit and a second bit of state data of the embedding entry are set to 0.

After that, when a read command READ is executed for the embedding entry by a normal access NA, the initial state S00 of the embedding entry transitions to an embedding state S10.

The normal access NA refers to accessing an embedding entry in the GPU memory 150 to perform an embedding operation of the current learning step.

In the embedding state S10, the first bit is set to 1 and the second bit is set to 0.

The embedding state S10 is maintained while the read command READ by the normal access NA is executed in the embedding state S10. A proactive access PA is ignored in the embedding state S10.

When a write command WRITE is executed by an update operation on the embedding entry in the embedding state S10, the state transitions to a reset state, e.g., the initial state S00.

If the write command WRITE by the update operation is executed as a result of performing the forward propagation operation and the backward propagation operation, a value of the embedding entry is updated and the learning operation for a current batch is terminated.

When a read command READ by the proactive access PA is executed in the initial state S00, the state transitions to a first proactive state S01.

The proactive access PA refers to a processing of an embedding entry that is not used in the current learning step but will be used in the next learning step, that is, it is accessed in advance for a proactive embedding operation.

In the first proactive state S01, the first bit is set to 0 and the second bit is set to 1.

The first proactive state S01 is maintained while the read command READ by the proactive access PA is executed in the first proactive state S01.

If a read command READ by the normal access NA is executed for the embedding entry in the first proactive state S01, the state of the embedding entry transitions to a second proactive state S11.

For example, the embedding entry that underwent the proactive embedding operation in the previous learning step starts the current learning step in the first proactive state S01.

When the read command READ by the normal access NA is executed for such an embedding entry, the state of the embedding entry transitions to the second proactive state S11.

In the second proactive state S11, the first bit is set to 1 and the second bit is set to 1.

Since the embedding operation has been completed for the embedding entry in the second proactive state S11, when a write command WRITE is executed by an update operation, the state transitions to the initial state S00.

As described above, when the write command WRITE is executed by the update operation as a result of performing the forward propagation operation and the backward propagation operation, the value of the embedding entry is updated, and the learning step is terminated.

Although various embodiments have been illustrated and described, various changes and modifications may be made to the described embodiments without departing from the spirit and scope of the invention as defined by the following claims. For example, in embodiments, the circuits described herein may include one or more processors and non-transient computer-readable media, and some operations described herein may be performed by the processors executing computer programming instructions stored on the non-transient computer-readable media.

What is claimed is:

1. A neural network accelerator, comprising:
a control circuit configured to control a learning operation for a neural network by performing a plurality of learning steps;
an operation processor configured to perform the learning operation under the control of the control circuit; and
an operation memory storing an embedding table and coupled to the operation processor,
wherein the operation processor performs a first embedding operation using an embedding entry required for a current learning step, and performs a second embedding operation using an embedding entry that is required for a next learning step and is not affected by the current learning step.

2. The neural network accelerator of claim 1, wherein the embedding table stores state data corresponding to a current state of an embedding entry.

3. The neural network accelerator of claim 2, wherein the operation processor sets a state of a given embedding entry in an initial state to an embedding state when the first embedding operation is performed on the given embedding entry, and the operation processor sets the state of the given embedding entry in the embedding state to the initial state after an update operation is performed on the given embedding entry.

4. The neural network accelerator of claim 2, wherein the operation processor sets a state of a given embedding entry in an initial state to a first proactive state when the second embedding operation is performed on the given embedding entry.

5. The neural network accelerator of claim 4, wherein the operation processor sets the state of the given embedding entry in the first proactive state to a second proactive state after the first embedding operation is performed on the given embedding entry, and the operation processor sets the state of the given embedding entry in the second proactive state to the initial state after an update operation is performed on the given embedding entry.

6. The neural network accelerator of claim 1, wherein the operation memory stores first input data used for the current learning step and second input data for the next learning step, and
wherein the operation processor determines the embedding entry required for the second embedding operation by referring to the first input data and the second input data.

7. An operation method of a neural network accelerator that performs a learning operation for a neural network and includes an embedding table, the operation method comprising:
performing a current learning step for learning the embedding table by using i-th batch data of learning data; and
performing a next learning step for learning the embedding table by using (i+1)-th batch data of the learning data,
wherein the current learning step includes:
performing a first embedding operation using an embedding entry of the embedding table that is required for the current learning step; and
performing a second embedding operation using an embedding entry of the embedding table that is required for the next learning step and is not affected by the current learning step, and
wherein i is a natural number.

8. The operation method of claim 7, wherein performing the first embedding operation includes setting a state of a given embedding entry in an initial state to an embedding state when performing the first embedding operation on the given embedding entry.

9. The operation method of claim 8, wherein the current learning step includes updating the given embedding entry in the embedding state and setting the state of the given embedding entry in the embedding state to the initial state.

10. The operation method of claim 7, wherein performing the second embedding operation includes setting a state of a given embedding entry in an initial state to a first proactive state when performing the second embedding operation on the given embedding entry.

11. The operation method of claim 10, wherein performing the first embedding operation includes setting the state of the given embedding entry in the first proactive state to a second proactive state when performing the first embedding operation on the given embedding entry.

12. The operation method of claim 11, wherein the current learning step includes updating the given embedding entry in the second proactive state and setting the state of the given embedding entry in the second proactive state to the initial state.
